(19) United States
(12) Patent Application Publication
(10) Pub. No.: US 2023/0102242 A1
(43) Pub. Date: Mar. 30, 2023

(54) PIERCE NUT

(71) Applicant: RAMCO SPECIALTIES, INC., Hudson, OH (US)

(72) Inventors: Mark S. BOYER, South Lyon, MI (US); John Scott ALEXANDER, Lake Orion, MI (US)

(21) Appl. No.: 17/904,650

(22) PCT Filed: Feb. 16, 2021
(86) PCT No.: PCT/US2021/018208

§ 371 Date: Aug. 19, 2022

Related U.S. Application Data
(60) Provisional application No. 62/979,701, filed on Feb. 21, 2020.

(51) Int. Cl. F16B 37/06

(52) U.S. Cl. CPC F16B 37/068

(57) ABSTRACT

The present disclosure is related to pierce nuts and, more particularly, to pierce nuts for thin and ultra-thin metal sheets. Exemplary embodiments of the present disclosure describe lightweight, high strength, structural nuts designed to pierce and clinch in ultra-high strength thin gage materials and ultra-thin metals. The pierce nuts include cavities radially disposed on a bottom surface having a teardrop radial form which allows for usage in thin ultra-high strength metals.

### CROSS REFERENCE TO RELATED APPLICATIONS

The application claims priority to and the benefit of U.S. Provisional Patent Application No. 62/979,701 filed Feb. 21, 2020, the disclosure of which is hereby incorporated herein in its entirety.

### FIELD

The present disclosure relates generally to a nut to be affixed to a sheet of material and more specifically to a pierce nut having a plurality of teardrop shaped cavities configured to drive the flow of sheet material toward a pilot portion.

### BACKGROUND

In manufacturing products from sheet metal panels, it is often necessary to attach adjacent panels together or to attach other components to panels utilizing threaded fasteners, e.g., screws and bolts. Generally, there are two types of nuts for this purpose, clinch nuts and pierce nuts. For a clinch nut, an aperture is pre-formed in a panel and the clinch nut is positioned against the panel with a pilot portion of the nut projecting through the pre-formed aperture. A pierce nut is similar to a clinch nut but is configured to forcefully punch through a panel to form its own aperture. Clinch and pierce nuts may be attached to the panel by a die member which forms a mechanical interlock between the nut and the panel. During the installation process, the panel is deformed by a die member into grooves disposed in the nut. The nut may be deformed to entrap panel metal.

Clinch and pierce nuts include a threaded or un-threaded hole that receives a threaded fastener. The threaded fasteners are tightened within the nut by rotation with rotating tools such as a screw driver or torque wrench. A nut affixed to a panel must have sufficient resistant to the torque that applied to the nut when a fastener is threaded therein. The affixed nut must also be able to withstand vibrations and tensile forces, e.g., when the nut is used in an automotive applications, which act to pull the nuts from the plate (pullout) to which they are attached.

There is a general trend toward the use of ultra-high strength thin gauge materials for reducing the amount of material used and weight of the final product. Current clinch and pierce nuts experience failures regarding torque resistance and pullout when used with ultra-high strength thin gauge metals (e.g., steel sheets having a hardness HRc 30-33) and ultra-thin metal sheets (e.g., ultra-thin aluminum sheets). The pierce nuts discussed herein relate certain improvements to address these and other issues.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In accordance with one aspect of the present disclosure disclosed is a pierce nut for attachment to a sheet of material. The pierce nut includes a generally cylindrical body with a top surface and an annular-shaped bottom surface. The pierce nut has an internal bore extending through the cylindrical body from the top surface to the bottom surface. A pilot portion is coaxial with the cylindrical body and extends outward from the bottom surface. A plurality of radially spaced apart cavities are recessed in the bottom surface surrounding the pilot portion, wherein each cavity includes a set of opposing spaced apart sidewalls having a teardrop-shaped vertical cross-section. The cavity has a substantially continuous base wall having a sloped portion that linearly increases in depth toward a center of the pierce nut that converges with a concave divot portion.

In some embodiments, the opposing spaced apart sidewalls are perpendicular to the bottom surface. In other embodiments, the opposing spaced apart sidewalls are inclined at an angle, the angle defined between a sidewall and a line perpendicular to the bottom surface and ranging from about 1 degree to about 7 degrees. In further embodiments, a sum of the angles for the spaced apart sidewalls of each cavity is less than or equal to about 12 degrees.

In some embodiments, the pierce nut further includes at least one planar tool receiving surface disposed on the nut body and adjacent to the top surface.

In some embodiments, the concave divot portion has an arcuate cross-section with a radius from about 0.1 mm to about 0.5 mm. In some further embodiments, the concave divot portion has an arcuate cross-section with a radius from about 0.2 mm to about 0.35 mm.

In some embodiments, the internal bore is threaded. The threads may be ISO metric screw threads in the range of M4 to M18. The threads may be English System Threads.

In some embodiments, the pilot portion comprises an exterior angled sidewall portion adjacent to the bottom surface. In some further embodiments, the pilot portion includes a substantially vertical exterior edge wall disposed between the exterior angled sidewall portion and a terminal end of the pilot portion.

In some embodiments, the pilot portion includes an inner surface wall in communication with the bore, where the inner surface wall having a diameter that increases toward a terminal end of the pilot portion.

In some embodiments, the bottom surface of the pierce nut is substantially flat.

In some embodiments, each cavity of the plurality of cavities is formed from three (3) faces.

In some embodiments, the number of the plurality of cavities is from 10 cavities to 13 cavities. In further embodiments, the number of the plurality of cavities is from 11 cavities to 12 cavities.

In some embodiments, each cavity gradually increases in depth from a peripheral edge surface of the bottom surface toward the pilot portion.

In some embodiments, the opposing spaced apart sidewalls are spaced apart at a distance from about 1.0 mm to about 2.0 mm.

In accordance with another aspect of the present disclosure disclosed are pierce nuts for attachment to a thin sheet of ultra-high strength metal. The pierce nut includes a generally cylindrical body having a central axis, a top surface and an annular-shaped bottom surface. The pierce nut includes an internal threaded bore extending through the cylindrical body from the top surface to the bottom surface configured to receive a fastener. A pilot portion of the pierce nut is coaxial with the cylindrical body and extends outward from the bottom surface. The pierce nut also includes a plurality of radially spaced apart cavities recessed in the bottom surface surrounding the pilot portion, wherein each cavity comprises opposed spaced apart sidewalls and a continuous base wall having a sloped portion that linearly increases in depth from a peripheral edge surface of the bottom surface toward the central axis and converging with a concave divot portion of an arcuate cross-section with a radius of from about 0.1 mm to about 0.5 mm.

These and additional features provided herein will be more fully understood in view of the following detailed description in conjunction with the drawings.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a perspective view illustration of an exemplary pierce nut in accordance with the present disclosure.

FIG. 2 is a cutaway side view of the pierce nut of FIG. 1.

FIG. 3 is a top view of the pierce nut of FIG. 1.

FIG. 4 is a bottom view of the pierce nut of FIG. 1.

FIG. 5 is a detailed cross-sectional view of a pierce nut pilot portion and cavity in accordance with the present disclosure.

FIG. 6 is an illustration of a teardrop shaped cavity for a pierce nut in accordance with the present disclosure.

FIG. 7 is a close-up illustration of the teardrop shaped cavity of FIG. 6.

FIG. 8 is a perspective view of the bottom portion of a pierce nut in accordance with the present disclosure.

FIG. 9 is a micrograph of a pierce nut installed to a sheet of material.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

The use of directional terms such as above, below, upper, lower, upward, downward, left, right, lateral and the like are used in relation to the illustrative embodiments as they are depicted in the figures, the upward or upper direction being toward the top of the corresponding figure and the downward or lower direction being toward the bottom of the corresponding figure.

As used herein, the terms “generally” and “substantially” are intended to encompass structural or numerical modifications which do not significantly affect the purpose of the element or number modified by such term.

The present disclosure is related to pierce nuts. Exemplary embodiments of the present disclosure describe lightweight, high strength, structural nuts designed to pierce and clinch in ultra-high strength thin gauge materials and ultra-thin metals. The nuts described herein have a reduced cross-sectional area required to insert the nut, while maintaining high torque resistance and pullout. The pierce nuts include cavities with a teardrop radial form which allow for usage in thin ultra-high strength metals. Reduced cross sectional area allows a nut to be positioned into constricted areas or close to an edge of a mating panel. This reduction is aided by ultra-high strength material. Minimized cross sectional area, material configuration and high level of heat treatment provide for a lightweight product.

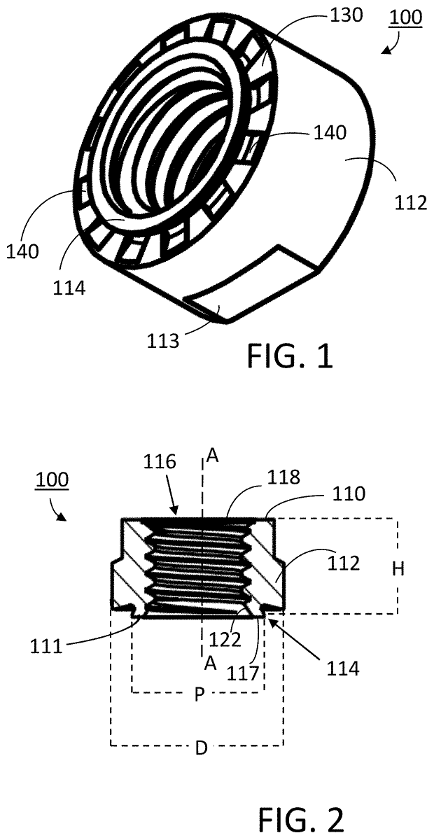

FIGS. 1-5 are various views of a pierce nut 100 for attachment to a metal plate that may incorporate the principles of the present disclosure. The illustrated pierce nut 100 has a generally cylindrical geometry and is just one exemplary pierce nut that may suitably incorporate the principles of the present disclosure. Indeed, many alternative designs, geometries, and configurations of the pierce nut 100 may be employed without departing from the scope of this disclosure, for example and without limitation hexagonal, octagonal, and other annual shapes.

In the illustrated embodiment, the pierce nut 100 may be manufactured from any number of materials depending on the particular application, including but not limited to metals (e.g., steel, titanium, iron, etc. and alloys thereof) and/or non-metals (e.g., carbon, carbon fiber, ceramic, etc.) Material type is chosen based on its performance in ultra-high strength metal plate applications as well its ability to withstand elevated heat treatment levels. Pierce nut is configured to attach to plate material up to HRc 35 hardness. Pierce nuts of the present disclosure may be formed complete from steel rod in coil form, in a horizontal, high speed nut or part forming machine.

With particular reference to FIGS. 1 and 2, the pierce nut 100 has a nut body 112 with opposing ends 110 and 111. In the illustrated embodiment, the pierce nut 100 includes a substantially circular top end 110 and substantially circular bottom end 111. The pierce nut 100 also includes a pilot portion 114 that extends from the bottom end 111 and is configured to punch an aperture through a panel or sheet of material.

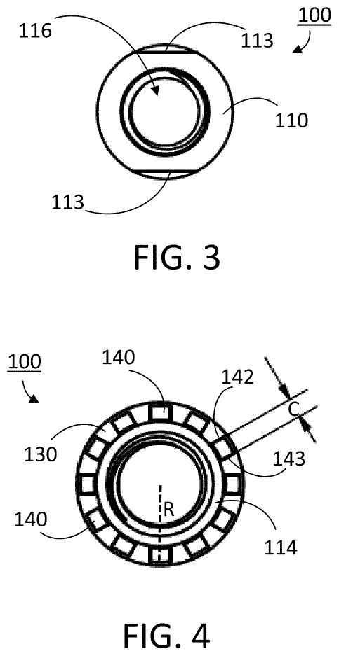

In some embodiments and as illustrated in FIGS. 1 and 3, the pierce nut body 112 further includes at least one tool portion 113 that is adapted to be received by a tool (e.g., a socket or wrench). In the illustrated embodiment, the nut body 112 includes two (2) vertically oriented faces 113 that may be received by an appropriately dimensioned tool driver having a corresponding geometry. The faces 113 extend perpendicularly from the top end 110 and along a height H of the body 112. In some embodiments, the opposing faces extend from the top end 110 to less than 100 percent of the height H of the body 112. In more particular embodiments, the opposing faces extend from the top end 110 to less than about 50 percent of the height H of the body 112. In some embodiments, and as illustrated in FIG. 3, the faces 113 are parallel and located on opposite sides of the nut 100. It is to be understood that while two parallel faces 113 are illustrated, that the number and configuration of faces 113 is not limiting and that additional faces having other configurations are contemplated, for example and without limitation, the body may include 6 faces 113 in a substantially hexagonal shape configured to receive a hexagonal socket wrench.

With reference to FIG. 1, the pierce nut 100 also includes a central bore 116 that extends axially through the height H of pierce nut 100 and along the axis A-A. In the illustrated embodiment, the central bore 116 includes a set of internal threads 118 that are formed within at least a portion of the central bore 116. In some embodiments, the bore 116 and internal threads 118 extend from the top surface 110 and through at least part of an inner surface wall 122 of the pilot portion 114. The internal threads 118 are sometimes referred to as the “nut thread” or “female thread,” and in at least some embodiments the internal threads 118 are cut or formed in the central bore 116 as will be appreciated by those skilled in the art.

The threads 118 may be of any standard size. For example and without limitation, the threads 118 may be any of the M4 thread size through the M18 thread size standards. It will be appreciated, however, that other “M” designation thread sizes may be utilized other than those in the M4 to M18 range. In one particular application, the threads 118 conform to General Motors (GM) Specification GMW 16551. In other embodiments, the threads 118 conform to any of the British thread standards, such as the British Standard Whitworth. In some of these other embodiments, threads 118 are about ¼″ to ¾″ English thread sizes; however, others may be utilized.

With particular reference to FIG. 2, the pilot portion 114 extends outward from the bottom end 111 and has an outer diameter P that is less than the diameter D of the bottom side 111. The pilot portion 114 has a terminal end 117 that is configured to punch a hole through a sheet of material upon the application of sufficient force. The pilot portion 114 also has an inner surface wall 122 and inner diameter in communication with the bore 116 and internal threads 118. In some embodiments, the terminal end 117 works together with a die to puncture a sheet of material when installing the pierce nut 100.

With reference to FIGS. 2, 4, 5 and 8, the pilot portion 114 includes an exterior angled sidewall portion 120 adjacent to the bottom surface 130, wherein the pilot portion 114 gradually widens from the bottom surface 130 toward the terminal end 117. In some embodiments, the pilot portion 114 includes an edge portion 119 located between the sidewall portion 120 and terminal end 117. The edge portion 119 is generally parallel to the center axis A-A and, in conjunction with the flat terminal end 117, creates a sharp point 115 for perforating a sheet.

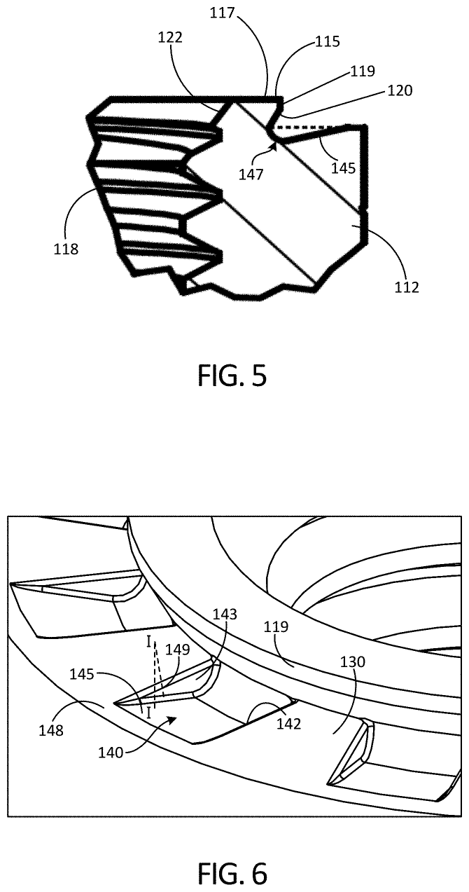

As described above, the inner surface wall 122 of the pilot portion 114 is in communication with the bore 116 and threads 118. In some embodiments, the threads 118 are continuous from the top side 110 of the nut 100 to the terminal end 117 of the pilot portion 114. In some embodiments and as illustrated in FIG. 5, the inner surface wall 122 is angled such that the inner bore 116 within the pilot portion 114 widens toward the terminal end 117. The angled surface (countersink), provides guidance for a fastener, such as a threaded bolt, into the bore of the pierce nut, and engage threads in nut, if present.

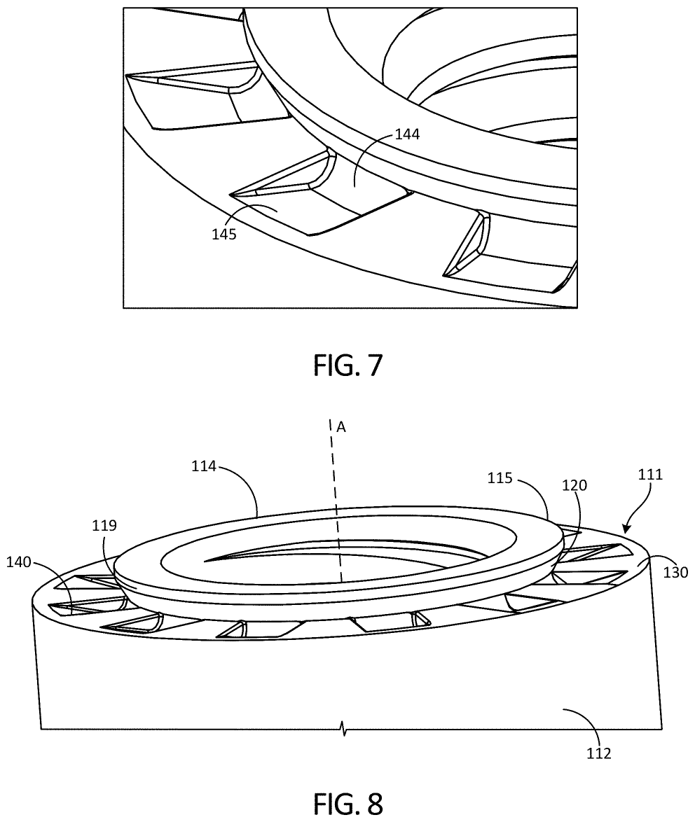

With reference to FIGS. 1, 2, 4 and 5, the bottom end 111 of the nut 100 is generally annular in shape having a substantially flat surface 130 that is perpendicular to the axis A-A. The substantially flat surface 130 is configured for contacting and clenching to a sheet of material, e.g., ultra-high strength metal. The bottom surface 130 includes a plurality of cavities 140 radially placed around and recessed into the annular surface 130. Each of the cavities 140 has a cross-section (along a radial R) that is generally teardrop shaped (as best illustrated in FIGS. 5-7) and a set of spaced apart opposing sidewalls 142, 143. In some embodiments and as illustrated in FIG. 4, the set of spaced apart opposing sidewalls 142, 143 are substantially parallel with a radius R passing through a center of the cavity. In other embodiments, each of the spaced apart opposing sidewalls 142, 143 are parallel to separate radii.

In some embodiments and as illustrated in FIG. 4, the bottom surface 130 includes 12 cavities 140. In other embodiments not illustrated, the bottom surface 130 includes 11 cavities 140. For example and without limitation, in some larger pierce nut embodiments, e.g., having a thread of M6 or greater, a pierce nut includes 12 cavities radially placed about the surface 130. In some smaller pierce nuts embodiments, e.g., having a thread of M5 or less, 11 cavities are radially placed about the surface 130. However, it is to be appreciated that the number of cavities 140 is not limiting and any number of cavities may be provided within the surface 130, including greater than 1 and less than 20, regardless of the size of the pierce nut. In some embodiments, the cavities 140 are substantially identical to one another. That is, the cavities 140 each have a substantially same size, depth, and shape. In other embodiments, cavities 140 may include cavities of various sizes and depths.

With continued reference to FIGS. 5-7, the teardrop shape is defined by having a cavity 140 that increases in depth toward the pilot portion 114 to a concave divot feature 144 of the cavity 140 having a radius 147. In other words, the cavity 140 has a sloped base 145 portion that converges with the radius 147 of the divot feature 144 in a continuous manner. Thus, the cavity 140 is formed from two sidewalls 142, 143 and continuous base wall that has a linear sloped portion 145 and a divot feature 144 having a radius 147. The sloped base portion 145 is preferably inclined at an angle of greater than 2 degrees and less than about 50 degrees relative to a plane perpendicular to the central axis A-A. Increasing the slope of the base 145 increases the depth and volume of the cavity. In some embodiments, the maximum depth of the cavity at its deepest part is from about 0.1 mm to about 0.5 mm. In some particular embodiments, the maximum depth of the cavity at its deepest part is from about 0.2 mm to about 0.35 mm. It is noted that the cavity 140 increases in depth in a substantially linear manner from a peripheral edge surface 148 of the bottom side 110 toward the divot feature 144. That is, the cavity 140 does not have abrupt change in depth along a radial line R of the pierce nut 100. The advantage of the substantially liner transition is a smooth flow of plate material forced toward the pilot wall. This pushes the plate material under the angled pilot and keeps the nut from being pushed out of the plate after assembly.

In the illustrated embodiment, the radius 147 of the divot feature 144 is from about 1.5 mm to about 0.5 mm. In some particular embodiments, the radius 147 is about 0.3 mm. The teardrop shape drives the flow of material into a divot feature 144 of the cavity 140. That is, during the application of the nut 100 to a sheet of material, the sheet material deforms such that material flows into the cavity 140 and is forced into the base of the teardrop (the divot feature 144). The displaced sheet material toward the pilot 114 (into the divot feature 144) enhances the pullout (or push-out) performance of the pierce nut 100.

With reference to FIG. 4, the inwardly extending sidewalls 142, 143 provide torque resistance properties to the nut 100, preventing the pierce nut 100 from rotating while affixed to a sheet of material. The sidewalls 142 143 are spaced apart at a distance C. In some particular embodiments, the spaced apart distance C ranges from about 1.0 mm to about 2.0 mm, including without limitation 1.2 mm, 1.4 mm, 1.6 mm, 1.8 mm and all values therebetween. In some embodiments, the spaced apart relationship is based on a ratio of the flat area on the nut base and the surface area of the divots.

In some embodiments and with reference to FIGS. 6 and 8, the inwardly extending sidewalls 142, 143 are substantially parallel to the axis A-A. In other embodiments, the inwardly extending sidewalls 142,143 are sloped at a small angle 149 with respect to an imaginary line I-I perpendicular to the bottom surface 130, such that the inwardly extending sidewalls 142,143 are closer together when evaluated at their bottom edges proximate to the sloped base 145 surface of the cavity 140 as compared to their top edges proximate to the flat surface 130 of the nut 100. In some embodiments, angle 149 is less than about 10 degrees. In some particular embodiments, the angle 149 is from about 5 to about 7 degrees wherein the sum of the angles 149 for each sidewall of a cavity 130 is not greater than 12 degrees. Generally, larger angles such as those greater than 10 degrees reduce the capability of the clinch nut to resist torque. However, in some examples, the inwardly extending sidewalls 142,143 are sloped or oriented away each other to at least a slight degree such that they are more spaced apart from each other when evaluated at their bottom edges as compared to their top edges.

The present disclosure is further illustrated in the following non-limiting working examples, it is being understood that these examples are intended to be illustrative only and that the disclosure is not intended to be limited to the materials, conditions, process parameters and the like recited herein.

### Examples

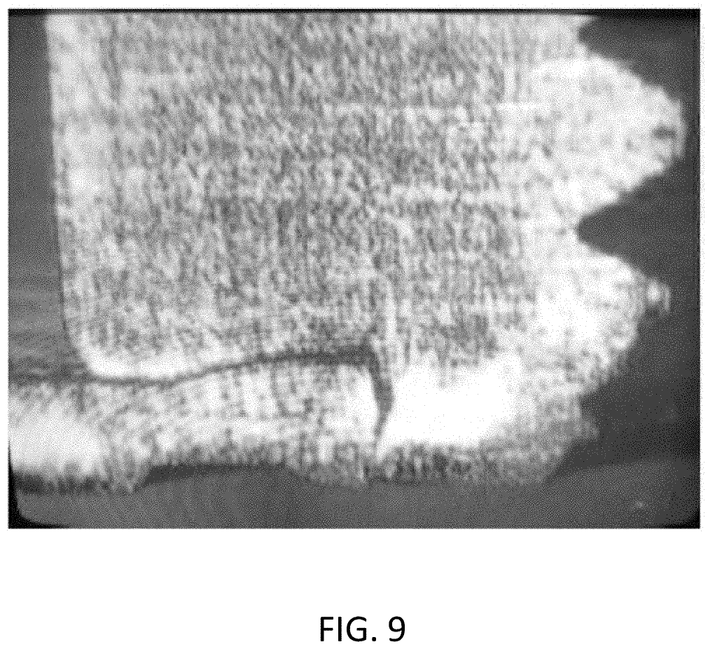

Example 1. An M6 threaded pierce nut was formed complete from steel rod in coil form, in a horizontal, high speed nut or part forming machine. The pilot portion of the piece nut was punched through a sheet of 0.65 mm thick Martensitic material having a hardness HRc 33. The nut was installed using a special shaped installation die button. FIG. 9 is a micrograph of an installed pierce nut cut to show the interaction between a sheet of material and teardrop shaped cavity. As illustrated in the micrograph, material of the Martensitic sheet was forced into the divot feature of the teardrop shaped cavity clinching the pierce nut to the sheet.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A pierce nut for attachment to a sheet of material comprising:
a generally cylindrical body having a top surface and an annular-shaped bottom surface;
an internal bore extending through the cylindrical body from the top surface to the bottom surface and configured to receive a fastener;
a pilot portion coaxial within the cylindrical body and extending outwardly from the bottom surface; and,
a plurality of radially spaced apart cavities recessed in the bottom surface surrounding the pilot portion, each cavity having a set of opposing spaced apart sidewalls and a teardrop shaped vertical cross-section comprising a substantially continuous base wall having a sloped portion that linearly increases in depth toward a center of the pierce nut and converging with a concave divot portion.

2. The pierce nut according to claim 1, wherein the opposing spaced apart sidewalls are perpendicular to the bottom surface.

3. The pierce nut according to claim 1, wherein the opposing spaced apart sidewalls are inclined at an angle, the angle defined between a sidewall and a line perpendicular to the bottom surface, the angle ranging from about 1 degree to about 7 degrees.

4. The pierce nut according to claim 3, wherein a sum of the angles for the spaced apart sidewalls of each cavity is less than or equal to about 12 degrees.

5. The pierce nut according to claim 1, further comprising at least one planar tool receiving surface disposed on the nut body and adjacent to the top surface.

6. The pierce nut according to claim 1, wherein the concave divot portion has an arcuate cross-section with a radius from about 0.1 mm to about 0.5 mm.

7. The pierce nut according to claim 1, wherein the concave divot portion has an arcuate cross-section with a radius from about 0.2 mm to about 0.35 mm.

8. The pierce nut of according to claim 1, wherein the internal bore is threaded.

9. The pierce nut according to claim 8, wherein the threads are ISO metric screw threads in the range of M4 to M18.

10. The pierce nut of claim 1, wherein the pilot portion comprises an exterior angled sidewall portion adjacent to the bottom surface.

11. The pierce nut according to claim 8, wherein the pilot portion comprises a substantially vertical exterior edge wall disposed between the exterior angled sidewall portion and a terminal end of the pilot portion.

12. The pierce nut according to claim 1, wherein the pilot portion comprises an inner surface wall in communication with the bore, the inner surface wall having a diameter that increases toward a terminal end of the pilot portion.

13. The pierce nut according to claim 1, wherein the bottom surface is flat.

14. The pierce nut according to claim 1, wherein each cavity of the plurality of cavities is formed from three (3) faces.

15. The pierce nut according to claim 1, wherein the plurality of cavities is from 10 cavities to 13 cavities.

16. The pierce nut according to claim 1, wherein the plurality of cavities is from 11 cavities to 12 cavities.

17. The pierce nut according to claim 1, wherein each cavity gradually increases in depth from a peripheral edge surface of the bottom surface toward the pilot portion.

18. The pierce nut according to claim 1, wherein the opposed spaced apart sidewalls are spaced apart at a distance from about 1.0 mm to about 2.0 mm.

19. A pierce nut for attachment to a thin sheet of ultra-high strength metal comprising:
a generally cylindrical body having a central axis, a top surface and an annular-shaped bottom surface;
an internal threaded bore extending through the cylindrical body from the top surface to the bottom surface configured to receive a fastener;
a pilot portion coaxial with the cylindrical body and extending outward from the bottom surface; and
a plurality of radially spaced apart cavities recessed in the bottom surface and surrounding the pilot portion, wherein each cavity comprises opposing spaced apart sidewalls and a continuous base wall having a sloped portion that linearly increases in depth from a peripheral edge surface of the bottom surface toward the central axis and converging with a concave divot portion of an arcuate cross-section with a radius of about 0.1 mm to about 0.5 mm.

20. The pierce nut according to claim 19, wherein the plurality of cavities is from 11 cavities to 12 cavities.
